(19) United States
(12) Patent Application Publication
(10) Pub. No.: US 2023/0313828 A1
(43) Pub. Date: Oct. 5, 2023

(54) MECHANICAL CONNECTOR

(71) Applicant: Mellanox Technologies Ltd., Yokneam (IL)

(72) Inventors: Ron Hartston, Yokneam (IL); Alex Garmash, Yokneam (IL)

(73) Assignee: Mellanox Technologies Ltd., Yokneam (IL)

(21) Appl. No.: 17/709,535

(22) Filed: Mar. 31, 2022

(51) Int. Cl. F16B 43/00

(52) U.S. Cl. CPC F16B 43/00

(57) ABSTRACT

A mechanical connector may include a first body and a second body, each having a first base surface and a second base surface, wherein the second base surface of the first body and the first base surface of the second body are inclined in a longitudinal direction and mating each other.

### FIELD OF THE INVENTION

The present invention relates to the field of mechanical connectors, and more particularly, to mechanical connectors for electronic devices.

### BACKGROUND OF THE INVENTION

Some components of an electronic device are connected to, for example, a frame of the electronic device or to each other using mechanical connectors such as bolts (e.g., spring-loaded bolts) that need to be tightened to provide axial forces that may maintain precision position of the components with respect to each other. However, application of too high axial force may damage components of the electronic device.

### SUMMARY OF THE INVENTION

Some embodiments of the present invention may provide a mechanical connector including: a first body and a second body, each having a first base surface and a second base surface; wherein the second base surface of the first body and the first base surface of the second body are inclined in a longitudinal direction and mating with each other.

In some embodiments, the second base surface of the first body and the first base surface of the second body are inclined at substantially the same angle relative to the longitudinal direction.

In some embodiments, the angle is within a range of 30°-80° with respect to a central longitudinal axis of the first body or the second body.

In some embodiments, the second base surface of the first body and the first base surface of the second body are flat.

In some embodiments, each of the first body and the second body has a hollow interior extending between the first base surface and the second base surface and along the entire length of the respective body.

In some embodiments, the mechanical connector includes a fastener extending through the hollow interiors of the first body and the second body.

In some embodiments, the fastener includes: a shaft having: a first end exiting externally from the hollow interior of the first body through the first base surface of the first body, and a second end exiting externally from the hollow interior of the second body through the second base surface of the second body; and a head connected to the first end of the shaft.

In some embodiments, the mechanical connector includes a spring positioned between the head of the fastener and the first base surface of the first body.

In some embodiments, the mechanical connector includes a retaining fastener connected to the shaft of the fastener external to the second body, the retaining fastener to hold the first body, the second body and the fastener united.

In some embodiments, the first body and the second body are substantially annular cylindrical bodies.

Some embodiments of the present invention may provide a mechanical connector including a first body and a second body having contacting base surfaces, the contacting base surfaces being inclined in a longitudinal direction at the same angle relative to a central longitudinal axis of the respective body.

In some embodiments, the angle is in a range of 30°-80°.

In some embodiments, each of the first body and the second body having a hollow interior extending along the entire length of the respective body, and the mechanical connector including a fastener extending through the hollow interiors of the first body and the second body.

In some embodiments, the fastener includes: a shaft having: a first end exiting externally from the hollow interior of the first body, and a second end exiting externally from the hollow interior of the second body; and a head connected to the first end of the shaft.

In some embodiments, the mechanical connector includes a spring between the head of the fastener and the first body.

In some embodiments, the mechanical connector includes a retaining fastener connected to the shaft of the fastener external to the second body, the retaining fastener to hold the first body, the second body and the fastener united.

In some embodiments, the first body and the second body are substantially annular cylindrical bodies.

Some embodiments of the present invention may provide a mechanical connector assembly including a first body and a second body having mating base surfaces, the mating base surfaces being inclined in a longitudinal direction; a first fastener including: a shaft extending through hollow interiors of the first body and the second body, the shaft having: a first end exiting externally from the hollow interior of the first body, and a second end exiting externally from the hollow interior of the second body; and a head connected to the first end of the shaft; and a second fastener connected to the shaft of the first fastener external to the second body, the second fastener to hold the first body, the second body and the first fastener united.

In some embodiments, the mating base surfaces are inclined in the longitudinal direction at the same angle relative to a central longitudinal axis of the respective body.

In some embodiments, the angle is in a range of 30°-80°.

In some embodiments, the mechanical connector assembly includes a spring positioned between the head of the first fastener and the first body.

### BRIEF DESCRIPTION OF THE DRAWINGS

For a better understanding of embodiments of the invention and to show how the same can be carried into effect, reference will now be made, purely by way of example, to the accompanying drawings in which like numerals designate corresponding elements or sections throughout.

In the accompanying drawings:

FIGS. 1A, 1B and 1C are three-dimensional (3D) diagrams of a mechanical connector, according to some embodiments of the invention;

FIGS. 1D and 1E are 3D diagrams of the mechanical connector including a fastener, according to some embodiments of the invention;

FIG. 1F is a 3D diagram of the mechanical connector in use with a structural element, according to some embodiments of the invention;

FIGS. 2A and 2B are 3D diagrams of the mechanical connector including a retaining fastener and a spring, according to some embodiments of the invention;

FIG. 2C is a schematic illustration of retaining fastener, according to some embodiments of the invention;

FIGS. 3A, 3B and 3C are 3D diagrams of a network switch device including the mechanical connectors, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention can be practiced without the specific details presented herein. Furthermore, well known features can have been omitted or simplified in order not to obscure the present invention. With specific reference to the drawings, it is stressed that the particulars shown are by way of example and for purposes of illustrative discussion of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention can be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that can be practiced or carried out in various ways as well as to combinations of the disclosed embodiments. Also, it is to be understood that the phraseology and terminology employed herein is for the purpose of description and should not be regarded as limiting.

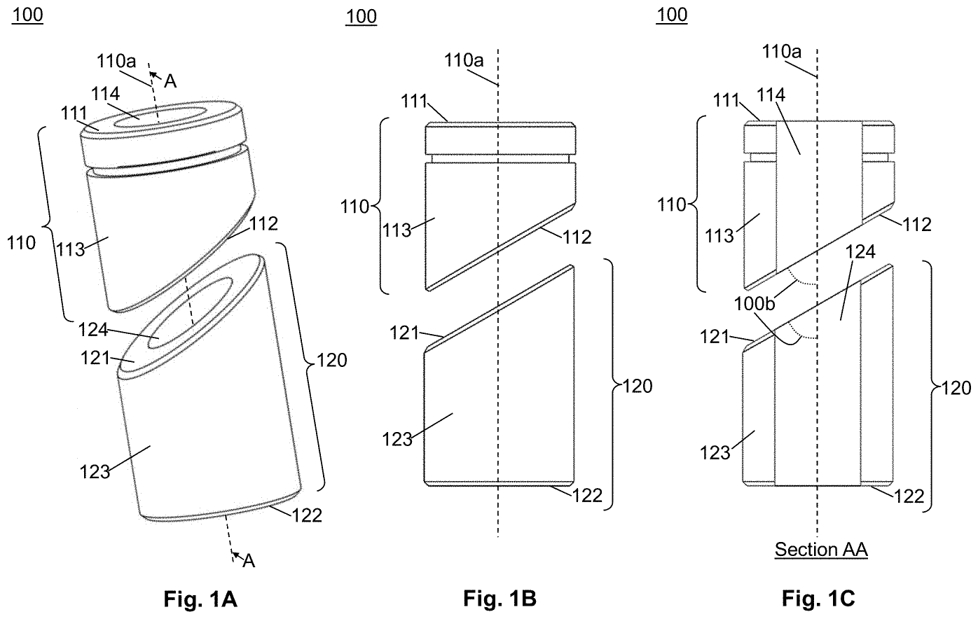

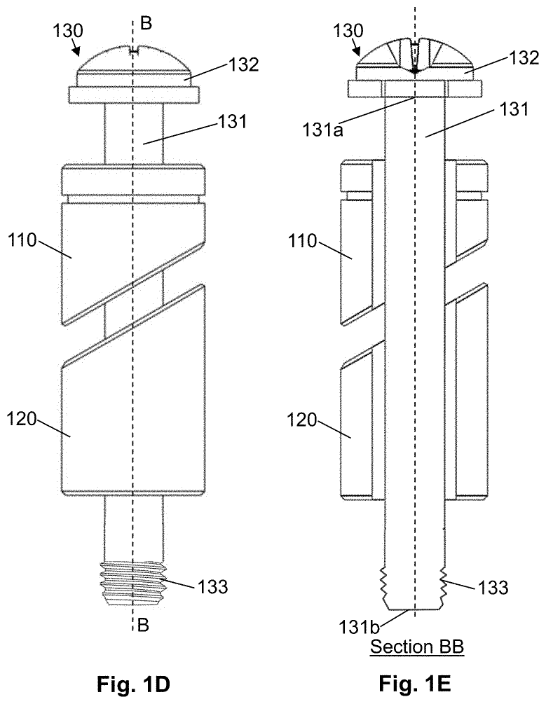

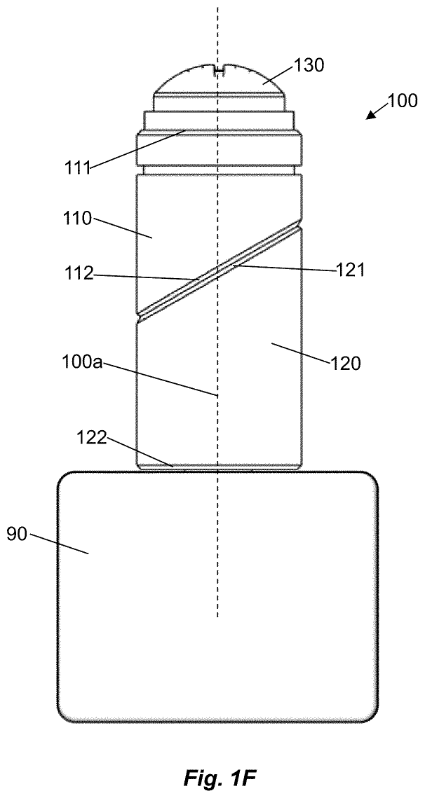

Reference is now made to FIGS. 1A, 1B and 1C, which are three-dimensional (3D) diagrams of a mechanical connector 100, according to some embodiments of the invention. FIG. 1A shows a perspective view of mechanical connector 100. FIG. 1B shows a side view of mechanical connector 100. FIG. 1C shows a partial longitudinal section view along line AA of FIG. 1A.

Mechanical connector 100 may include a first body 110 and a second body 120. First body 110 and second body 120 may be, for example, annular cylindrical (or substantially cylindrical) bodies (e.g., as shown in FIGS. 1A-1C). In another example, first body 110 and second body 120 may each have a polygonal transverse cross-section, e.g., substantially square transverse cross-section. First body 110 may have a first base surface 111, a second base surface 112 and a lateral surface 113 extending between first base surface 111 and second base surface 112 and forming a hollow interior 114 of first body 110. Second body 120 may have a first base surface 121, a second base surface 122 and a lateral surface 123 extending between first base surface 121 and second base surface 122 and forming a hollow interior 124 of second body 120. Base surface 111 and base surface 112 may each be a plane at the end of generally cylindrical first and second bodies 110 and 120, respectively.

Second base surface 112 of first body 110 and first base surface 121 of second body 120 may be inclined in a longitudinal direction 100a of mechanical connector 100 (e.g., being also a central longitudinal axis of first body 110 and a central longitudinal axis of second body 120, as shown in FIGS. 1A-1C). When first body 110 and second body 120 are pressed to each other, second base surface 112 of first body 110 and first base surface 121 of second body 120 may mate or contact with each other (e.g., as described below with respect to FIG. 1F). Second base surface 112 of first body 110 and first base surface 121 of second body 120 may be flat (or substantially flat). Second base surface 112 of first body 110 and first base surface 121 of second body 120 may be inclined at the same (or substantially the same) angle 100b relative to longitudinal direction 100a. Second base surface 112 of first body 120 and first base surface 121 of second body 120 may be or may be aligned with planes which are offset or angled from the longitudinal axis of first body 110 and second body 120 at a non-ninety degree and non-180° degree angle. Inclination angle 100b may be within a range of 30°-80°. In the example shown in FIGS. 1A-1C, inclination angle 100b is 60° relative to longitudinal direction 100a. This is in contrast to the case where first body 110 and second body 120 are cylinders with right-angled ends, such that inclination angle 100b would be 90°.

Reference is now made to FIGS. 1D and 1E, which are 3D diagrams of mechanical connector 100 including a fastener 130, according to some embodiments of the invention. FIG. 1E shows a side view of mechanical connector 100. FIG. 1D shows a partial longitudinal section view of mechanical connector 100 along line BB of FIG. 1E.

Mechanical connector 100 may include a fastener 130. Fastener 130 may include a shaft 131 having a first end 131a and a second end 131b, and a head 132 connected to first end 131a of shaft 131. Shaft 131 of fastener 130 may extend through hollow interiors 114, 124 of first body 110 and second body 120, respectively. First end 131a of shaft 131 may exit externally from hollow interior 114 of first body 110. Second end 131b of shaft 131 may exit externally from hollow interior 124 of second body 120. Fastener 130 may include an external thread 133 at or adjacent to second end 131b of shaft 131. For example, fastener 130 may be a bolt, a screw or any other fastener.

Reference is now made to FIG. 1F, which is a 3D diagram of mechanical connector 100 in use with a structural element 90, according to some embodiments of the invention. FIG. 1F shows side view of mechanical connector 100 and structural element 90.

When fastener 130 of mechanical connector 130 is turned or rotated about longitudinal direction 100a to e.g., connect fastener 130 to structural element 90, fastener 130 and structural element 90 may press first body 110 and second body 120 to each other causing second base surface 112 of first body 110 and first base surface 121 of second body 120 to mate or contact with each other.

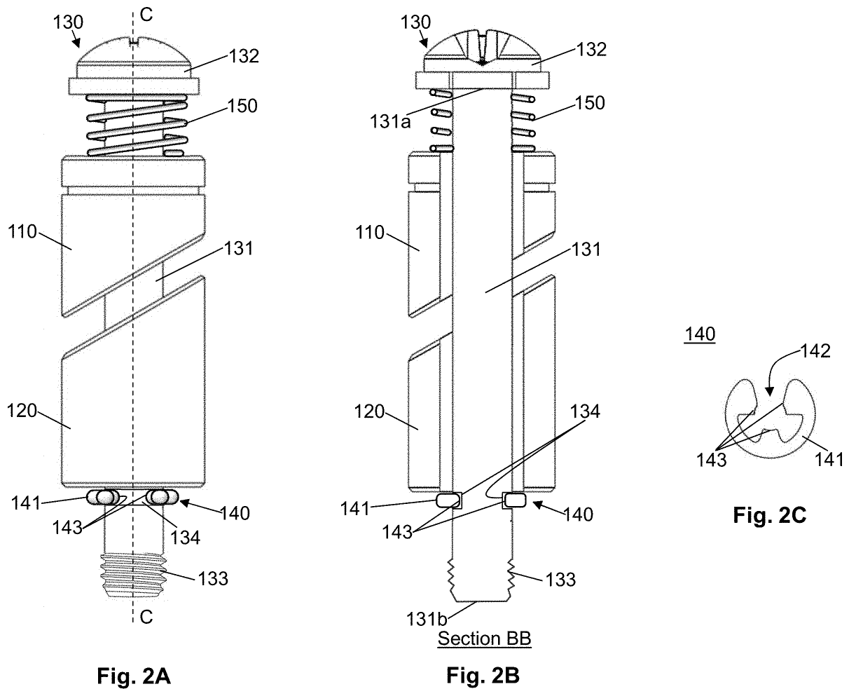

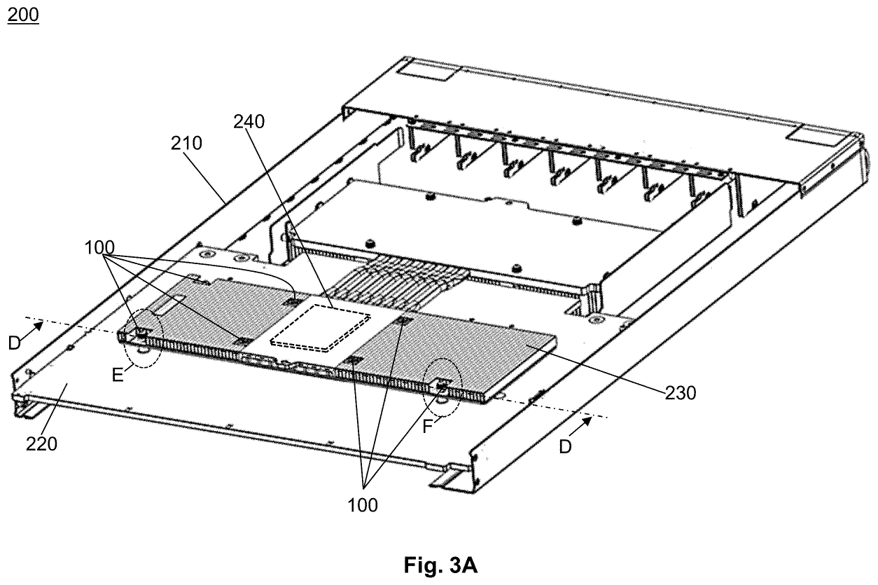

Reference is now made to FIGS. 2A and 2B, which are 3D diagrams of mechanical connector 100 including a retaining fastener 140 and a spring 150, according to some embodiments of the invention. FIG. 2A shows a side view of mechanical connector 100. FIG. 2B shows a partial longitudinal section view of mechanical connector 100 along line CC of FIG. 2A.

Reference is also made to FIG. 2C, which is a schematic illustration of retaining fastener 140, according to some embodiments of the invention. FIG. 2C shows a top view of retaining fastener 140.

Mechanical connector 100 may include a retaining fastener 140. Retaining fastener 140 may be connected to shaft 131 of fastener 130 between second end 131b of shaft 131 and second base surface 122 of second body 120 (e.g., as shown in FIGS. 2A-2B). Retaining fastener 140 may limit axial motion of first body 110 and second body 120 with respect to shaft 131 of fastener 130. Retaining fastener 140 may hold first body 110, second body 120 and fastener 130 united. Retaining fastener 140 may, for example, be or include a washer, a retaining ring or any other fastener.

For example, retaining fastener 140 may have an annular (or substantially annular) body 141 including: an opening 142 through which shaft 131 of fastener 130 may be inserted into an interior of annular body 141; and radial protrusions 143 protruding internally from annular body 141 (e.g., as shown in FIGS. 2A, 2B and 2C). Shaft 131 of fastener 130 may include a groove 134 on the external surface of shaft 131 that may receive radial protrusions 143 of retaining fastener 140 to limit axial motion of retaining fastener 140, first body 110 and second body 120 with respect to shaft 131 of fastener 130 (e.g., as shown in FIGS. 2A, 2B and 2C). While retaining fastener 140 is embodied in FIGS. 2A-2C as an e-ring fastener, retaining fastener 140 may be any retaining fastener 140 known in the art.

Mechanical connector 100 may include a spring 150 positioned between head 132 of fastener 130 and first end 111 of first body 110 (e.g., as shown in FIGS. 2A-2B). In some other embodiments, spring 150 is not required.

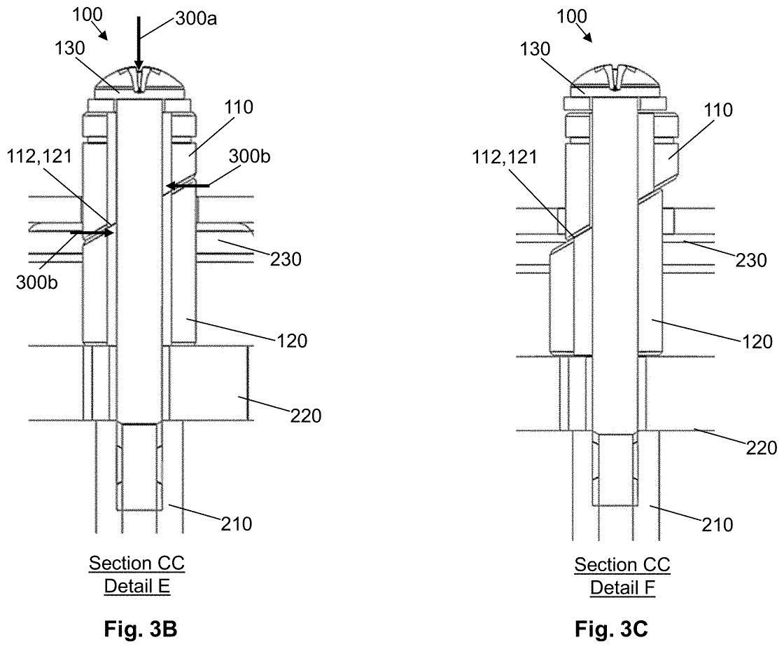

Embodiments of mechanical connectors 100 may be used in, for example, an electronic device to connect components of the electronic device to, for example, a frame of the electronic device or to connect the components to each other. Connection of components of the electronic device using mechanical connectors 100 may ensure positioning of the components in the device with high precision while reducing axial forces applied on the components as compared to prior art mechanical connectors (e.g., as described hereinbelow with respect to FIGS. 3A, 3B and 3C).

Reference is now made to FIGS. 3A, 3B and 3C, which are 3D diagrams of a network switch device 200 including mechanical connectors 100, according to some embodiments of the invention. FIG. 3A shows a perspective view of network switch device 200. FIGS. 3B and 3C shows a partial section view network switch device 200 along line DD of FIG. 3A. FIG. 3B shows an enlarged view E of FIG. 3A. FIG. 3C shows an enlarged view F of FIG. 3A.

Network switch device 200 may include a frame 210, a printed circuit board (PCB) 220, a heat sink 230, a chip 240 and, optionally, other mechanical and/or electronic components. Precious positioning of, for example, heat sink 230 with respect to chip 240 may be required to ensure proper cooling of chip 240 using heat sink 230. Chip 240 may be sensitive to mechanical loads. For example, axial forces applied on chip 240 by heat sink 230 due to tight mechanical connection of heat sink 230 to frame 210 may damage chip 240.

Mechanical connectors 100 may be used, for example, to connect heat sink 230 to frame 210 to place heat sink 230 with respect to chip 240 with high precision, while reducing overall axial forces applied on heat sink 230 and chip 240 by mechanical connectors 100 as compared to prior art mechanical connectors such as bolts or spring-loaded bolts. As shown in FIG. 3B, when axial forces 300a are applied on fasteners 130 of mechanical connectors 100, inclined mating or otherwise contacting base surfaces 112, 121 of bodies 110, 120 of mechanical connectors 100 may convert a portion of axial forces 300a to lateral forces 300b (e.g., being substantially perpendicular to axial forces 300a), thus reducing overall axial forces being applied on heat sink 230 and chip 240 by mechanical connectors 100 as compared to prior art mechanical connectors that have no axial-lateral force conversion mechanisms. As shown in FIG. 3C, bodies 110, 120 of mechanical connectors 100 may move and self-align with respect to each other to compensate, e.g., for positional differences and/or tolerances between respective holes in heat sink 230, PCB 220 and/or frame 210, thus increasing an overall positioning precision of heat sink 230 with respect to chip 240 as compared to prior art mechanical connectors that have no self-aligning mechanisms.

While device 200 is descried as a network switch device, other devices may include mechanical connectors 100, and different components of these devices may be connected using mechanical connectors 100.

Advantageously, the disclosed mechanical connectors 100 may be used to connect components of, for example, an electronic device with higher positioning precision while applying lower axial forces on these components as compared to prior art mechanical connectors.

In the above description, an embodiment is an example or implementation of the invention. The various appearances of “one embodiment”, “an embodiment”, “certain embodiments” or “some embodiments” do not necessarily all refer to the same embodiments. Although various features of the invention can be described in the context of a single embodiment, the features can also be provided separately or in any suitable combination. Conversely, although the invention can be described herein in the context of separate embodiments for clarity, the invention can also be implemented in a single embodiment. Certain embodiments of the invention can include features from different embodiments disclosed above, and certain embodiments can incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A mechanical connector comprising:
a first body and a second body, each having a first base surface and a second base surface;
wherein the second base surface of the first body and the first base surface of the second body are inclined in a longitudinal direction and mating with each other.

2. The mechanical connector of claim 1, wherein the second base surface of the first body and the first base surface of the second body are inclined at substantially the same angle relative to the longitudinal direction.

3. The mechanical connector of claim 2, wherein the angle is within a range of 30°-80° with respect to a central longitudinal axis of the first body or the second body.

4. The mechanical connector of claim 1, wherein the second base surface of the first body and the first base surface of the second body are flat.

5. The mechanical connector of claim 1, wherein each of the first body and the second body have a hollow interior extending between the first base surface and the second base surface and along the entire length of the respective body.

6. The mechanical connector of claim 5, further comprising a fastener extending through the hollow interiors of the first body and the second body.

7. The mechanical connector of claim 6, wherein the fastener comprises:
a shaft having: a first end exiting externally from the hollow interior of the first body through the first base surface of the first body, and a second end exiting externally from the hollow interior of the second body through the second base surface of the second body; and
a head connected to the first end of the shaft.

8. The mechanical connector of claim 7, further comprising a spring positioned between the head of the fastener and the first base surface of the first body.

9. The mechanical connector of claim 7, further comprising a retaining fastener connected to the shaft of the fastener external to the second body, the retaining fastener to hold the first body, the second body and the fastener united.

10. The mechanical connector of claim 1, wherein the first body and the second body are substantially annular cylindrical bodies.

11. A mechanical connector comprising:
a first body and a second body having contacting base surfaces, the contacting base surfaces being inclined in a longitudinal direction at the same angle relative to a central longitudinal axis of the respective body.

12. The mechanical connector of claim 11, wherein the angle is in a range of 30°-80°.

13. The mechanical connector of claim 11, wherein each of the first body and the second body having a hollow interior extending along the entire length of the respective body, and the mechanical connector comprising a fastener extending through the hollow interiors of the first body and the second body.

14. The mechanical connector of claim 13, wherein the fastener comprises:
a shaft having: a first end exiting externally from the hollow interior of the first body, and a second end exiting externally from the hollow interior of the second body;
a head connected to the first end of the shaft.

15. The mechanical connector of claim 14, further comprising a spring between the head of the fastener and the first body.

16. The mechanical connector of claim 14, further comprising a retaining fastener connected to the shaft of the fastener external to the second body, the retaining fastener to hold the first body, the second body and the fastener united.

17. A mechanical connector assembly comprising:
a first body and a second body having mating base surfaces, the mating base surfaces being inclined in a longitudinal direction;
a first fastener comprising:
a shaft extending through hollow interiors of the first body and the second body, the shaft having: a first end exiting externally from the hollow interior of the first body, and a second end exiting externally from the hollow interior of the second body; and
a head connected to the first end of the shaft; and
a second fastener connected to the shaft of the first fastener external to the second body, the second fastener to hold the first body, the second body and the first fastener united.

18. The mechanical connector assembly of claim 17, wherein the mating base surfaces are inclined in the longitudinal direction at the same angle relative to a central longitudinal axis of the respective body.

19. The mechanical connector assembly of claim 18, wherein the angle is in a range of 30°-80°.

20. The mechanical connector assembly of claim 17, further comprising a spring positioned between the head of the first fastener and the first body.
